(19) United States
(12) Patent Application Publication
(10) Pub. No.: US 2009/0276331 A1
(43) Pub. Date: Nov. 5, 2009

(54) Method for Linking Network Virtual Service to Physical Service of a Physical Shop

(76) Inventors: Ming-Shen SUN, Hsinchu City (TW); Hwei-Tsu Luh, Hsinchu City (TW)

Correspondence Address: Dr. BANGER SHIA, 102 Lindencrest Ct., Sugar Land, TX, 77479-5201, US

(21) Appl. No.: 12/114,771

(22) Filed: May 3, 2008

(51) Int. Cl. G06Q 30/00; G06Q 20/00; G06F 3/048

(52) U.S. Cl. 705/27; 715/764

(57) ABSTRACT

A method for linking network virtual service to physical service of a physical shop, wherein a shop owner provides a network service platform to the customers for performing a primary virtual service, saving the service content by free or charge account and assisting the customers in finishing the physical service. Such a method can assist the physical shop in attracting the customers related to the physical shop via the network quickly and effectively and providing a previous situation simulation of the physical service to the customer to increase the confidence and satisfaction index and achieving the high satisfaction of the service and further making the service more professional.

### BACKGROUND OF THE INVENTION

1. Field of the Invention

The present invention relates to a method for linking network virtual service to physical service of a physical shop, wherein the physical shop provides a network service platform to the customers for performing primary virtual service, saving the service content by free or charge account and assisting the customer in finishing the physical service.

2. Description of the Prior Art

The network information technology has provided many virtual services, such as online auction service or online book service. As for the companies selling physical goods, the network is also an effective marketing channel, but as for the companies providing physical service, such as hair and beauty service or health & physical therapy service, the network information technology has not been found to provide any more direct and effective marketing tools and methods except the introductory websites.

In recent years, a network advertising player has been developed on the market to bring advertising content either in the form of video or picture into the public or commercial space, such as elevator, marketplace, waiting area, etc. However, the current broadcasting of the advertising content is limited to one-way broadcasting and the advertising contents are too diverse and should be classified, and the viewing environment is full of much interference, so it is unlikely to achieve the effect of deep marketing.

The single-function KIOSK machines are another example of applying the information technology in the physical service, but most of them are designed as single-function automatic machines, such as automatic teller machine or dish-booking machine, so it only has the advantages of saving labor and flow automatization but doesn't have the function of attracting consumers actively. Particularly for the network application, it doesn't provide the interaction between the service provider and the consumer.

The present invention has arisen to mitigate and/or obviate the afore-described disadvantages.

### SUMMARY OF THE INVENTION

The primary objective of the present invention is to provide a method for linking network virtual service to physical service of a physical shop, which relates to linking a network information server to the network and providing a virtual service network program similar or related to the physical service of a physical shop. The customer or other users links the computer to the network to enter the program interface of the virtual service, so as to select, edit the service items and saves the finished record in the network information server. The customer can go to the physical shop that provides physical service according to prompt and links the computer in the physical shop to the network information server at one end of the network and search out the virtual service record saved by the customer. The service specialist in the physical shop makes a confirmation, suggestion and then executes service. After the physical service is finished, the payment can be directly made by network, cash or by membership card.

The above operation can achieve online interaction between the customer and the physical shop and provide service to the customer more conveniently and an alternative commercial marketing development mode to the service provider.

In order to achieve the above objective, the entire flow of the physical shop service in accordance with the present invention comprises the steps of: logging in the network information server, then selecting and editing the service items on the service interface of the network information server, and guiding the user or customer to the appointed physical shop after confirming the related information of the physical shop, using the computer in the physical shop to enter the service interface of the network information server to search out the content that is edited by the user or customer previously, and making payment by the customer or user after subsequently the service specialist in the physical shop makes a confirmation, suggestion and executes service, and finally conducting a telephone interview and a marketing operation after service.

The secondary objective of the present invention is to provide a method which particularly relates to a process of linking virtual and physical service that shows how a customer books a service online and receives physical service in a physical shop, wherein the flow showing how the physical shop commercial marketing development obtains business opportunity and delivery service comprises the steps of: the customer or user can enter the service interface of the network server via the computer in the physical shop and then selects and books the products and the physical service items on the service interface, and finally the related suppliers will supply the goods and the payment is made.

Another objective of the present invention is to provide a method for linking network virtual service to physical service of a physical shop. Since the customer or user saves both the service items selected previously and the service content information that is altered during physical service in the network service platform, the service specialist or the owner of the physical shop can directly collect the information of the customer on the service interface of the network information for facilitating the marketing operation and improving the usage of the information in the network information server by the physical shop.

Another objective of the present invention is to provide a method for linking network virtual service to physical service of a physical shop, wherein the user selects and edits the items on the service interface of the network information server after logging in the network information server and then enters the flow of confirming the related information of the physical shop and conducting the sequent operation, thus providing the objective of combining the virtual and physical service.

Hence, the network virtual service in accordance with the present invention provides the serial operation of the customer terminal, the physical shop terminal and the network information terminal and can provide the online interaction between the customer and the physical shop directly, so as to provide service to the customer conveniently and an alternative commercial marketing development mode to the service provider, thus achieving the practical objective of connecting the customer with the network, physical shop, personal website, company website, virtual website hard disc or virtual website server.

### BRIEF DESCRIPTION OF THE DRAWINGS

FIG. 1 is a schematic view of the relative relationship in accordance with the present invention;

FIG. 2 is a second schematic view of the relative relationship in accordance with the present invention;

FIG. 3 is a flow chart of linking virtual and physical service that shows how the customer books a service online and receives physical service in the physical shop in accordance with the present invention; and

FIG. 4 is a flow chart of a commercial marketing development for a physical shop in accordance with the present invention.

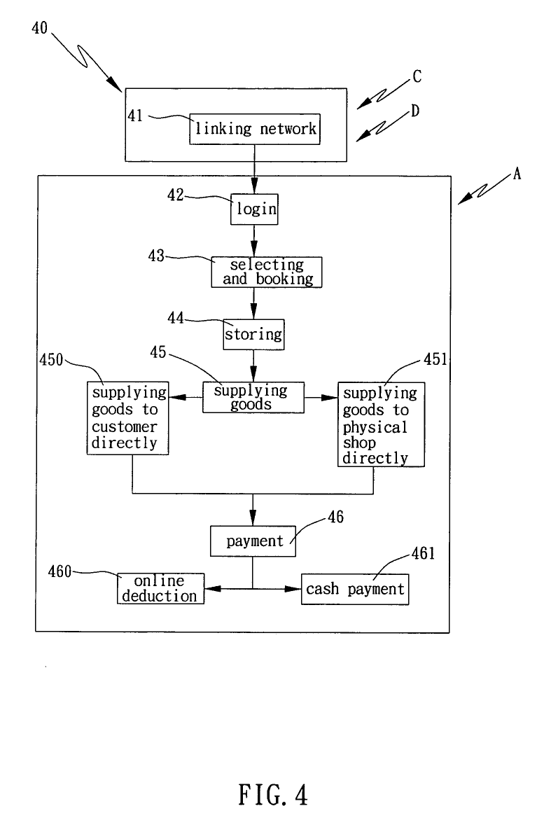

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

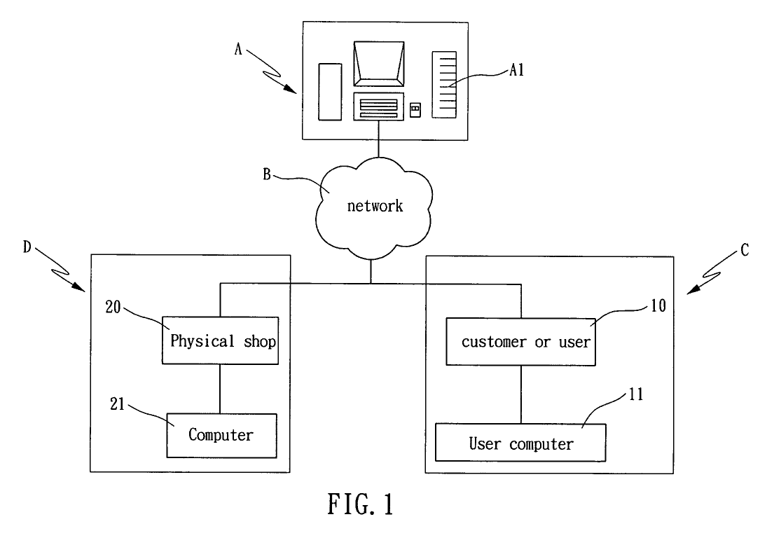

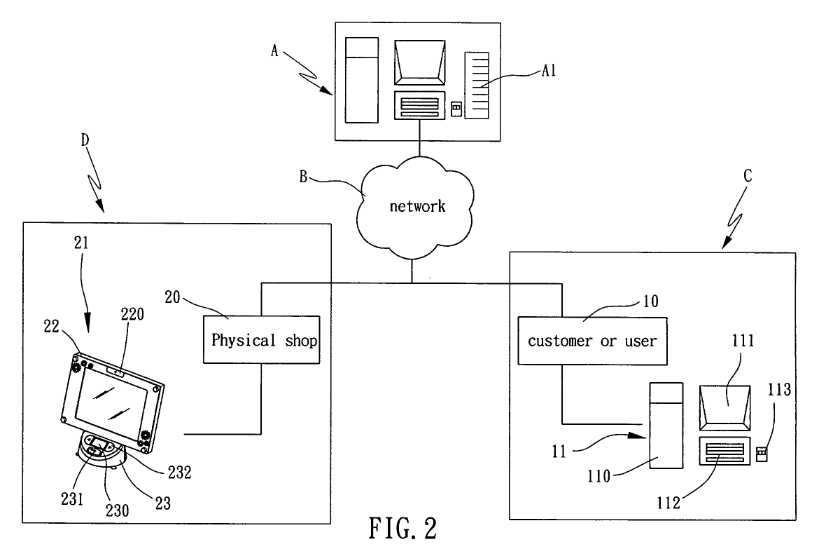

Referring to FIGS. 1-2, a method for linking network virtual service to physical service of a physical shop, which essentially comprises linking a network information server A to one end of a network B and linking the other end of the network B to the customer terminal C and the physical shop terminal D. The customer terminal C is connected to the network B via the user computer 11 of the customer or user 10 and enters the predetermined service interface A1 of the network information server A to select, edit and confirm the service location and items of the physical shop 20, and then saves the finished record in the network information server A for the customer's reference. The customer or user 10 arrived in the physical shop terminal D can also log on the network B via the computer 21 of the physical shop terminal D and enter the service interface A1 of the network information sever A to check the finished record saved therein. The customer or user 10 can directly go to the appointed physical shop 20 and use the computer 21 in the physical shop 20 to log on the network B and enter the network information server A to search out the saved record, and the service specialist will provide services of the confirming, advising, selecting and editing, and the payment can be made directly after service is finished.

The above method can directly provide mutual interaction between the customer or user 10 and the physical shop 20 via the network B, thus conveniently offering the service to the customer or user 10 and providing another marketing development mode to the service provider.

The user computer 11 of the customer or user 10 includes a mainframe 110, a display 111, a keyboard 112 and a mouse 113 and is connected to the information server A via the network B.

The physical shop 20 includes a computer 21 to be operated by the customer or user 10. The computer 21 includes a display 22 and a base 23. The display 22 is provided on the base 23, and the display 22 is provided with a capturing element 220. The base 23 is provided with a touch pad 230, a rolling element 231 and a plurality of touch elements 232. The capturing element 220 of the display 22 is used for the user to capture image or perform the online interaction. In addition, the touch pad 230, the rolling element 231 and the respective touch element 232 of the base 23 are provided for the user to perform the selecting operation present on the display 22. The content present on the display 22 can be directly and effectively operated and controlled without using other external structures.

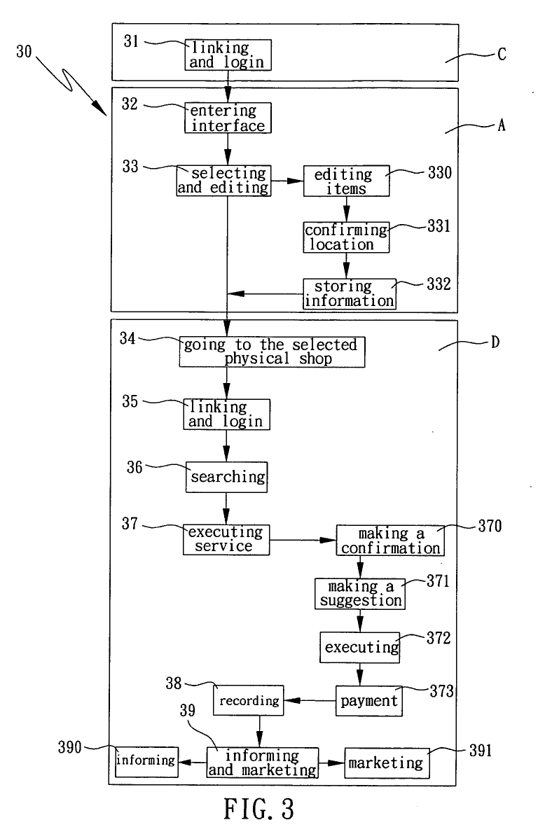

In order to achieve the above objective, referring to FIG. 3, a flow 30 of linking virtual and physical service that shows how the customer books a service online and receives physical service in the physical shop in accordance with the present invention comprises the following steps:

starting from the customer terminal C;

linking and login 31: the customer or user 10 at the customer terminal C links the user computer 11 to the network information server A via the network B and inputs the ID of the customer or user 10 to log in the network information server A terminal;

entering interface 32: after login, a service interface A1 will be shown on the display for allowing the customer or user 10 to establish the information in the mainframe 110 of the user computer 11 or transfer photos or search out the related necessary information (such as hair and beauty, massage, etc);

selecting and editing 33: the customer or user 10 selects and edits the required service items displayed on the service interface A1;

editing items 330: taking hair and beauty as an example, the editing items include the editing of hair style and photos, face beauty service and body point massage, such a system can also be applied in other industries that require professional service, such as massage industry, pet barber & beauty industry, and the distribution industry of costume jewelry and shoes;

confirming location 331: after editing the required service items, the customer or user 10 will select and confirm the location of the physical shop 20;

saving information 332: saving the edited items and the selected location of the shop 20;

going to the selected physical shop 34: the customer or user 10 goes to the selected physical shop 20 to use the display 22 and the base 23 of the computer 21 in the physical shop 20;

entering the physical shop terminal D;

linking and login 35: the customer or user 10 inputs his ID and the ID of the physical shop 20 on the display 22 of the computer in the physical shop 20;

searching 36: the customer or user 10 searches out the edited items that are previously saved in the network information server A via the network B;

executing service 37: the service specialist in the physical shop 20 makes a confirmation, suggestion and then executes service as follows:

making a confirmation 370: the service specialist makes a confirmation with the customer or user 10 the selected service items;

making a suggestion 371: the service specialist makes a suggestion on the selected service items for the customer or user 10;

executing 372: after the customer or user 10 confirms the selected items and takes the suggestion of the service specialist, the service specialist executes the service items selected by the customer or user 10;

payment 373: after the service specialist executes the service items selected by the customer or user 10, the payment may be made by deduction on the service interface A1 of the network information server A via the network B or by cash or by membership card deduction, meanwhile, the customer or user 10 can exit his ID;

recording 38: recording down the time and date that the customer or user 10 received the service and the amount of money that has been paid;

informing and marketing 39: the owner of the physical shop 20 informs the customer or user 10 of the time and date that the customer or user 10 received the service and the amount of money that has been paid and informs him of the marketing information:

informing 390: the owner of the physical shop 20 checks the time and date that the customer or user 10 received the service and the amount of money that has been paid on the service interface A1 of the network information server A via the network B and invites the customer or user 10 to go to the physical shop 20 to enjoy service again; and

marketing 391: when the owner of the physical shop 20 issues the related activity information, the information will be sent to the mobile phone or mail box of the customer or user 10 to inform him of the activity and the promotion products of the physical shop 20.

The present invention can be also directly applied at the physical shop terminal D as a commercial marketing development flow 40 for the physical shop, which can be directly performed at the physical shop terminal D by the customer or user 10 or the owner of the physical shop 20 and comprises the steps of:

linking network 41: the customer or user 10 can utilize the display 22 and the base 23 of the computer 21 in the physical shop 20 to link the network B to perform the sequent operation;

login 42: after linking the network B, the customer or user 10 can input his ID to enter the service interface A1;

selecting and booking 43: the customer or user 10 or the owner of the physical shop 20 selects and books the products or the relating items on the service interface A1, and the owner of the physical shop 20 can collect and analyze the information of the customer or user 10 or provides business information to the customer or user 10 on the service interface A1;

saving 44: after confirming the booked products or the relating items, the customer or user 10 or the owner of the physical shop 20 saves the information about the booked products or the relating items in the network information server A;

supplying goods 45: after being saved, the information about the selected and booked products is directly sent to the supplier, and then the supplier will supply the products or the relating items that are booked by the customer or user 10 or the owner of the physical shop 20 by the following two ways 450, 451:

supplying goods to customer directly 450 : the customer or user 10 or the owner of the physical shop 20 can select supplying goods directly to his home or the related location;

supplying goods to physical shop directly 451: the customer or user 10 or the owner of the physical shop 20 can select supplying the goods to the physical shop 20 directly, and the customer or user 10 can use or fetch the goods directly in the physical shop 20;

payment 46: after the operation of supplying goods is finished, the payment is made, and there are provided two payment methods as follows:

online deduction 460: after receiving or booking the goods, the customer or user 10 or the owner of the physical shop 20 can make the payment via the network B bank or by means of credit card directly;

cash payment 461: the customer or user 10 or the owner of the physical shop 20 can pay in cash directly while receiving the goods at home or the physical shop 20 or the related pickup location.

The above method can achieve the interaction between the customers and the physical shop 20 through the network B to provide service to the customer or user 10 conveniently and provide an alternative commercial marketing development mode method to the service provider.

The user 10 can also enter the network information server A directly via the network B and performs the virtual operation in advance on the service interface A1, so as to observe if the physical operation is desirable and to determine to give up or execute the physical operation directly after confirmation, so as to satisfy the requirements of the user 10.

In addition, in the flow 30 of linking virtual and physical service that shows how the customer books a service online and receives physical service in the physical shop and the commercial marketing development flow 40 for the physical shop, the network B can be also linked by the user computer 11 of the user or the customer by the computer connected to the network information server A at the network information server A terminal for performing of the sequent operation.

Hence, the network virtual service in accordance with the present invention provides the serial operation of the customer terminal, the physical shop terminal and the network information terminal and can provide the interaction between the customer and the physical shop via the network directly, so as to provide service to the customer conveniently and an alternative commercial marketing development mode to the service provider, thus achieving the practical objective of connecting the customer with the network, physical shop, personal website, company website, virtual website hard disc or virtual website server.

While we have shown and described various embodiments in accordance with the present invention, it is clear to those skilled in the art that further embodiments may be made without departing from the scope of the present invention.

What is claimed is:

1. A method for linking network virtual service to physical service of a physical shop mainly comprising the steps of: linking a network information server to a network, and linking the other end of the network to a customer terminal and a physical shop terminal, wherein the customer terminal uses a user computer of a customer or user to link with the network and enter a predetermined service interface of the network information server of the network to select, edit and confirm a service location and service items of the physical shop, and then saves a finished record in the network information server for customer's reference, the customer or user arrived in the physical shop terminal also log on the network via the computer of the physical shop terminal and enter the service interface of the network information sever to check the finished record saved therein;
the customer or user directly goes to an appointed physical shop and uses a computer in the physical shop to log on the network and enter the network information server to search out the saved record, and then a service specialist provides services of confirming, advising, selecting and editing, and payment is then made directly after service is finished.

2. The method for linking network virtual service to physical service of a physical shop as claimed in claim 1, wherein a flow of linking virtual and physical service that shows how a customer books a service online and receives physical service in a physical shop in accordance with the present invention comprises the following steps:
starting from the customer terminal;
linking and login: the customer or user at the customer terminal links the user computer to the network information server via the network and inputs an ID of the customer or user to log in the network information server terminal;
entering interface: after login, a service interface will be shown on a display of the user computer for allowing the customer or user to establish the information in a mainframe of the user computer or transfer photos or search out related necessary information;
selecting and editing: the customer or user selects and edits required service items displayed on the service interface;
editing items: taking hair and beauty as an example, editing items include editing of hair style and photos, face beauty service and body point massage, such a system is also applied in other industries that require a professional service;
confirming location: after editing the required service items, the customer or user will select and confirm a location of the physical shop; and
saving information: saving edited items and a location of the shop selected by the customer or user;

3. The method for linking network virtual service to physical service of a physical shop as claimed in claim 1, wherein the user computer of the customer or user includes a mainframe, a display, a keyboard and a mouse is connected to the information server via the network.

4. The method for linking network virtual service to physical service of a physical shop as claimed in claim 1, wherein the physical shop includes a computer to be operated by the customer or user, the computer includes a display and a base, the display is provided on the base is provided with a capturing element, the base is provided with a touch pad, a rolling element and a plurality of touch elements, the capturing element of the display is used for the user to capture image or perform online interaction, the touch pad, the rolling element and the respective touch elements of the base are provided for the user to perform a selecting operation present on the display, a content present on the display is directly and effectively operated and controlled without using other external structures.

5. The method for linking network virtual service to physical service of a physical shop as claimed in claim 1, wherein the user directly enters the network information server via the network and performs a virtual operation in advance on the service interface, so as to observe if a physical operation is desirable and determine to give up or execute the physical operation directly after confirmation, so as to satisfy requirements of the user.

6. A method for linking network virtual service to physical service of a physical shop, wherein it relates to a flow of linking virtual and physical service that shows how a customer receives physical service in a physical shop, which comprising the steps of:
going to a selected physical shop: a customer or user goes to the selected physical shop to use a display and a base of a computer in the physical shop;
entering a physical shop terminal;
linking and login: the customer or user inputs his ID and an ID of the physical shop on the display of the computer in the physical shop;
searching: the customer or user searches out edited items that are previously saved in a network information server via a network;
executing service: a service specialist in the physical shop makes a confirmation, suggestion and then executes service as follows:
making a confirmation: the service specialist makes a confirmation with the customer or user service items that are selected by the customer or user;
making a suggestion: the service specialist makes a suggestion on the service items selected by the customer or user;
executing: after the customer or user confirms the service items selected by the customer or user and takes the suggestion of the service specialist, the service specialist executes the service items selected by the customer or user;
payment: after the service specialist executes the service items selected by the customer or user, payment is made by deduction on a service interface of the network information server via the network or by cash or by membership card deduction, meanwhile, the customer or user exits his ID;
recording: recording down a time and date that the customer or user received the service and the amount of money that has been paid;
informing and marketing: an owner of the physical shop informs the customer or user of the time and date that the customer or user received the service and the amount of money that has been paid and informs him of marketing information:
informing: the owner of the physical shop checks the time and date that the customer or user received the service and the amount of money that has been paid on the service interface of the network information server via the network and invites the customer or user to go to the physical shop to enjoy service again; and
marketing: when the owner of the physical shop issues related activity information, the information will be sent to a mobile phone or mail box of the customer or user to inform him of the activity and promotion products of the physical shop.

7. The method for linking network virtual service to physical service of a physical shop as claimed in claim 6 starting from the customer terminal:
linking and login: the customer or user at the customer terminal links the user computer to the network information server via a network and inputs the ID of the customer or user to log in the network information server terminal;
entering interface: after login, the service interface will be shown on a display of the user computer for allowing the customer or user to establish the information in a mainframe of the user computer or transfer photos or search out related necessary information;
selecting and editing: the customer or user selects and edits required service items displayed on the service interface;
editing items: taking hair and beauty as an example, editing items include editing of hair style and photos, face beauty service and body point massage, such a system is also applied in other industries that require professional service;
confirming location: after editing the required service items, the customer or user will select and confirm a location of the physical shop;
saving information: saving edited items and a location of the shop selected by the customer or user;
going to a selected physical shop: the customer or user goes to the selected physical shop to use the display and the base of the computer in the physical shop;
entering the physical shop terminal;
linking and login: the customer or user inputs his ID and an ID of the physical shop on the display of the computer in the physical shop;
searching: the customer or user searches out the edited items that are previously saved in the network information server via a network;
executing service: the service specialist in the physical shop makes the confirmation, suggestion and then executes service as follows:
making a confirmation: the service specialist makes the confirmation with the customer or user service items that are selected by the customer or user;
making a suggestion: the service specialist makes the suggestion on the service items selected by the customer or user;
executing: after the customer or user confirms the service items selected by the customer or user and takes the suggestion of the service specialist, the service specialist executes the service items selected by the customer or user;
payment: after the service specialist executes the service items selected by the customer or user, payment is made by deduction on the service interface of the network information server via the network or by cash or by membership card deduction, meanwhile, the customer or user exits his ID;
recording: recording down the time and date that the customer or user received the service and the amount of money that has been paid;
informing and marketing: the owner of the physical shop informs the customer or user of the time and date that the customer or user received the service and the amount of money that has been paid and informs him of the marketing information:
informing: the owner of the physical shop checks the time and date that the customer or user received the service and the amount of money that has been paid on the service interface of the network information server via the network and invites the customer or user to go to the physical shop to enjoy service again; and
marketing: when the owner of the physical shop issues related activity information, the information will be sent to the mobile phone or mail box of the customer or user to inform him of the activity and promotion products of the physical shop.

8. The method for linking network virtual service to physical service of a physical shop as claimed in claim 6, wherein the network virtual service provides a serial operation of the customer terminal, the physical shop terminal and the network information terminal and provides interaction between the customer and the physical shop via the network directly, so as to provide service to the customer conveniently and an alternative commercial marketing development mode to a service provider, thus achieving the practical objective of connecting the customer with the network, physical shop, personal website, company website, virtual website hard disc or virtual website server.

9. A method for linking network virtual service to physical service of a physical shop, wherein a commercial marketing development flow for a physical shop which is directly performed at a physical shop terminal by a customer or user or an owner of a physical shop, comprises the steps of:
linking network: the customer or user links a network to perform sequent operation in the physical shop;
login: after linking the network, the customer or user inputs his ID to enter a service interface;
selecting and booking: the customer or user or the owner of the physical shop selects and books products or relating items on the service interface, and the owner of the physical shop collects and analyzes information of the customer or user or provides business information to the customer or user on the service interface;
saving: after confirming the booked products or the relating items, the customer or user or the owner of the physical shop saves the information about the booked products or the relating items in a network information server;
supplying goods: after being saved, the information about the selected and booked products is directly sent to the supplier, and then the supplier will supply the products or the relating items that are booked by the customer or user or the owner of the physical shop by the following two ways:
supplying goods to customer directly: the customer or user or the owner of the physical shop selects supplying goods directly to his home or a related location;
supplying goods to physical shop directly: the customer or user or the owner of the physical shop selects supplying goods to the physical shop directly, and the customer or user uses or fetches the goods directly in the physical shop;
payment: after the operation of supplying goods is finished, payment is made, and there are provided two payment methods as follows:
online deduction: after receiving or booking the goods, the customer or user or the owner of the physical shop makes payment via a network bank or by means of credit card directly;
cash payment: the customer or user or the owner of the physical shop pays in cash directly while receiving the goods at home or the physical shop or a related pickup location.

10. The method for linking network virtual service to physical service of a physical shop as claimed in claim 9, the customer or user links the network via a display and a base of a computer in the physical shop to perform the sequent operation;

11. The method for linking network virtual service to physical service of a physical shop as claimed in claim 9, the customer or user links the network via a user computer of the customer or user to perform the sequent operation.

12. The method for linking network virtual service to physical service of a physical shop as claimed in claim 9, the customer or user links the network via a computer connected to the network information server at a network information server terminal to perform the sequent operation.
